(19) United States
(12) Patent Application Publication
(10) Pub. No.: US 2011/0160407 A1
(43) Pub. Date: Jun. 30, 2011

(54) NOVEL POLYAMIDEIMIDES AND PREPARATION AND COMPOSITIONS COMPRISED THEREOF

(75) Inventors: Franck Touraud, Communay (FR); Veronique Bossennec, Serezin De Rhone (FR); Stephane Jeol, Lyon (FR)

(73) Assignee: RHODIA OPERATIONS, AUBERVILLIERS (FR)

(21) Appl. No.: 12/997,208

(22) PCT Filed: Jun. 5, 2009
(86) PCT No.: PCT/EP2009/056915

§ 371 Date: Jan. 31, 2011

(30) Foreign Application Priority Data
Jun. 12, 2008 (FR) 08/03263

(51) Int. Cl. C08L 79/08; C08G 73/14; B29C 49/06; B29C 49/04; B29C 45/00

(52) U.S. Cl. 525/435; 528/350; 264/537; 264/540; 264/328.1; 528/289

(57) ABSTRACT

Novel semi-aromatic polyamideimides are prepared by melt polymerization of at least one organic compound having carboxyl groups, of at least one diamine compound and, optionally, of at least one diacid compound; such novel polyamideimides are formulated into compositions based on a thermoplastic matrix.

The present invention relates to a process for the preparation of a semiaromatic polyamide-imide and to a polyamide-imide and a composition based on a thermoplastic matrix comprising a polyamide-imide. The invention relates more particularly to a process for the preparation of polyamide-imide by melt polymerization of at least one organic compound having carboxyl groups, of at least one diamine compound and optionally of at least one diacid compound.

Polyamide-imides are polymers of great industrial and commercial interest. They are used in particular in the field of flame-resistant textiles or injection-molded parts having a high thermal resistance. Among them, semiaromatic polyamide-imides are particularly advantageous in terms of properties. This is because they exhibit properties intermediate between aromatic polyamide-imides, on the one hand, and, for example, aliphatic polyamides, on the other hand. Aromatic polyamide-imides are high performance polymers having very good mechanical properties. However, they are difficult to synthesize and convert by the molten route, in contrast to aliphatic polyamides. Semiaromatic polyamide-imides can be converted more easily than aromatic polyamide-imides (they exhibit a glass transition temperature and a melting point lower than the melt forming temperatures) and they exhibit better mechanical and thermomechanical properties than those of the aliphatic polyamides.

Processes for the preparation of aromatic or semiaromatic polyamide-imides are known. These processes are generally processes for the preparation of polyamide-imides in solution in organic solvents. The use of organic solvents exhibits major disadvantages. First, the recovery of a polymer after synthesis requires additional stages, such as the precipitation of the polymer from a nonsolvent and the washing and the drying of the polymer. Secondly, some solvents are toxic and thus dangerous to man and the environment.

The invention thus provides a process for the preparation of semiaromatic polyamide-imides which does not exhibit these disadvantages.

Thus, the invention provides, in a first subject matter, a process for the preparation of semiaromatic polyamide-imides by melt polymerization of at least the following monomers:
a) at least one organic compound, preferably an aromatic organic compound, comprising at least two carboxyl groups, preferably at least three carboxyl groups, the carboxyl groups being present in the form of functional groups chosen from carboxylic acid, acid chloride, acid anhydride, amide or ester functional groups, at least two of the carboxyl groups forming an intramolecular anhydride functional group or being able to form an intramolecular anhydride functional group,
b) at least one diamine compound, preferably an aliphatic diamine compound,
c) optionally at least one diacid compound,
when all the carboxyl groups of the compound a) form an intramolecular anhydride functional group or can form an intramolecular anhydride functional group, the molar proportion of compound c) with respect to the sum of the compounds a) and c) is greater than or equal to 0.5%, advantageously greater than or equal to 25%, preferably greater than or equal to 50%.

In a second subject matter, the invention provides a polyamide-imide comprising the following repeat units:

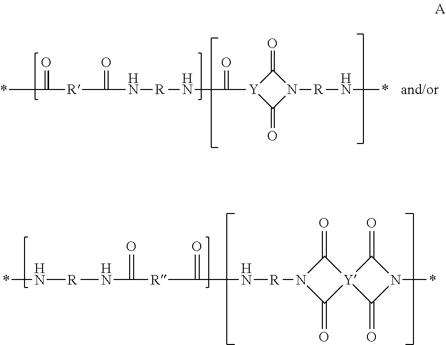

with R and R′ being aliphatic, cycloaliphatic or arylaliphatic hydrocarbon radicals, advantageously aliphatic or cycloaliphatic hydrocarbon radicals, preferably comprising between 2 and 18 carbon atoms,
R″ being a hydrocarbon radical preferably comprising between 2 and 18 carbon atoms,
Y being a trivalent aromatic hydrocarbon radical,
Y′ being a tetravalent aromatic hydrocarbon radical,
or a polyamide-imide comprising the following repeat units:

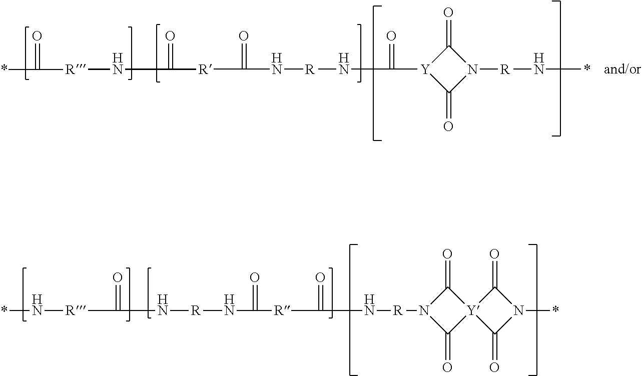

with R, R′ and R″ being hydrocarbon radicals preferably comprising between 2 and 18 carbon atoms,
R′″ being an aromatic hydrocarbon radical preferably comprising between 2 and 18 carbon atoms,
Y being a trivalent aromatic or aliphatic hydrocarbon radical, preferably an aromatic hydrocarbon radical,
Y′ being a tetravalent aromatic or aliphatic hydrocarbon radical, preferably an aromatic hydrocarbon radical.

In a third subject matter, the invention provides a thermoplastic polymer composition comprising the semiaromatic polyamide-imide of the invention described above or obtained by the process of the invention described above. Finally, in a fourth subject matter, the invention relates to the articles obtained by forming the composition of the invention.

The process for the preparation of the polyamide-imide of the invention employs, as a monomer, at least one organic compound a), preferably an aromatic organic compound.

The compound a) exhibits at least three functional groups chosen from carboxyl groups and amine groups.

Advantageously, the compound a) comprises three or four carboxyl groups, preferably three or four carboxylic acid functional groups.

The compound a) can, for example, comprise at least a pair of carboxyl groups in the ortho position with respect to one another.

According to a specific embodiment of the process of the invention, the compound a) is of following formula (I):

Z—(COOH)₃

in which Z is a trivalent aromatic radical.
Z can be a trivalent radical of benzene, naphthalene, biphenyl, diphenyl ether, diphenyl sulfide, diphenyl sulfone, ditolyl ether, and the like.

Advantageously, Z comprises between 6 and 18 carbon atoms.

This specific embodiment of the process of the invention employs carboxylic acids, which are generally less toxic than the equivalent carboxylic anhydrides.

The compound a) is preferably chosen from trimellitic acid, pyromellitic acid, their anhydrides, their esters or their amides.

Advantageously, the compound a) does not comprise an imide functional group.

The compound a) can also be a compound comprising an amine group and two carboxyl groups. Mention may be made, as examples of such compounds, of aspartic acid, 3-aminophthalic acid or 4-aminophthalic acid.

In the context of the invention, mixtures of different compounds a) can be employed.

The process for the preparation of the polyamide-imide of the invention employs, as monomer, at least one diamine compound b).

The diamines of use in the present invention advantageously have the formula H₂N—R—NH₂ (II) in which R is a divalent hydrocarbon radical, in particular an aliphatic, aromatic or arylaliphatic diradical or a substituted derivative of these diradicals. The radical R advantageously comprises between 2 and 18 carbon atoms.

The term “arylaliphatic diamine” is understood to mean a diamine, at least one of the amine functional groups of which is not attached to a carbon atom forming part of an aromatic ring.

Suitable aliphatic diamines comprise straight-chain aliphatic diamines, such as 1,10-diaminodecane, branched-chain aliphatic diamines, such as 2-methyl-1,6-diaminohexane, and cycloaliphatic diamines, such as di(aminomethyl)cyclohexanediamines.

The aliphatic chain can comprise heteroatoms, such as sulfur or oxygen, such as represented by 3,3′-ethylenedioxybis(propylamine), and it can also carry substituents, such as halogen atoms, which do not react under the polymerization conditions.

Aromatic diamines suitable in the present invention comprise diamines in which R in the general formula is the phenylene group, a fused aromatic group, such as the naphthylene group, or two (or more) bonded aromatic nuclei, such as represented by bisphenylene, bisphenylenemethane, bisphenylenepropane, bisphenylene sulfone, bisphenylene ether and the like. Furthermore, any of the aromatic groups can carry one or more substituents on the nucleus, such as low alkyl groups or halogen atoms, which do not react under the polymerization conditions. The diamine preferably comprises from 2 to 18 carbon atoms, more preferably from 4 to 12 carbon atoms. Particularly suitable diamines comprise diamines of the homologous series H₂N(CH₂)mNH₂ in which m is an integer from 2 to 12, preferably from 4 to 8, and diamines of general formula H₂N(CH₂)ₚZ(CH₂)_{g}NH₂ in which Z is a phenylene radical and p and q are independently 1, 2 or 3.

Advantageously, the compound b) is an aliphatic diamine.

The diamines can, for example, be chosen from hexamethylenediamine, butanediamine, 2-methylpenta-methylenediamine, 2-methylhexamethylenediamine, 3-methylhexamethylenediamine, 2,5-dimethylhexamethylene-diamine, 2,2-dimethylpentamethylenediamine, nonane-diamine, 5-methylnonanediamine, dodecamethylenediamine, 2,2,4- and 2,4,4-trimethylhexamethylenediamine, 2,2,7,7-tetramethyloctamethylenediamine, meta-xylylene-diamine; para-xylylenediamine, isophoronediamine, diaminodicyclohexylmethane and C₂-C₁₆ aliphatic diamines which can be substituted by one or more alkyl groups. The preferred diamine is hexamethylenediamine.

Mixtures of diamines can also be used in the present invention to produce polymers having repeat units in which the group represented by R in the general formula for the polymers refers to two or more different diradicals.

Advantageously, at least 45 mol %, preferably at least 50 mol %, of the diamine compound is an aliphatic, cycloaliphatic or arylaliphatic diamine.

The process for the preparation of the polyamide-imide of the invention also optionally employs, as monomer, at least one diacid compound c).

Advantageously, the compound c) is of the following formula (III):

HOOC—R′—COOH (III)

in which R′ is a divalent aliphatic, cycloaliphatic, aryaliphatic or aromatic hydrocarbon radical.

Preferably, the radical R′ comprises between 2 and 18 carbon atoms.

The term “arylaliphatic diacid” is understood to mean a diacid, at least one of the acid functional groups of which is not attached to a carbon atom forming part of an aromatic ring.

According to a specific embodiment of the process of the invention, the compound c) is an aliphatic diacid. The aliphatic acid can, for example, be chosen from oxalic acid, maleic acid, succinic acid, pimelic acid or azelaic acid. It can also comprise unsaturations; this is the case, for example, with maleic acid or fumaric acid.

The dicarboxylic acids can also be chosen from glutaric acid, adipic acid, suberic acid, sebacic acid, dodecanedioic acid, 1,2- or 1,3-cyclohexanedicarboxylic acid, 1,2- or 1,3-phenylenediacetic acid, 1,2- or 1,3-cyclohexanediacetic acid, isophthalic acid, terephthalic acid, 4,4′-benzophenonedicarboxylic acid, 2,5-naphthalenedicarboxylic acid and p-(t-butyl)isophthalic acid. The preferred dicarboxylic acid is adipic acid.

In the context of the invention, mixtures of different compounds c) can be employed.

Advantageously, the process of the invention does not comprise aliphatic amino acid or lactam monomers, preferably does not comprise lactams or amino acids, such as caprolactam, 6-aminohexanoic acid, 5-aminopentanoic acid, 7-aminoheptanoic acid, aminoundecanoic acid or dodecanolactam.

Advantageously, the process of the invention does not comprise diol monomers. This is because the presence of such monomers can, for example, be reflected by a low viscosity of the polymers obtained, which is not desirable.

The process for the preparation of the polyamide-imide of the invention comprises a melt polymerization of the monomers a), b) and optionally c).

The expression “melt polymerization” is understood to mean that the polymerization is carried out in the liquid state and that the polymerization medium does not comprise a solvent other than water, optionally. The polymerization is carried out in a continuous liquid phase. The polymerization medium can, for example, be an aqueous solution comprising the monomers or a liquid comprising the monomers. Advantageously, the polymerization medium comprises water as solvent. This facilitates the stirring of the medium and thus its homogeneity.

The polymerization medium can also comprise additives, such as chain-limiting agents.

The polyamide-imide of the invention is generally obtained by polycondensation between the compound a), the compound b) and optionally the compound c) to form polyamide-imide chains with formation of the elimination product, in particular water, a portion of which may vaporize.

The polyamide-imide of the invention is generally obtained by heating, at high temperature and high pressure, for example an aqueous solution comprising the monomers or a liquid comprising the monomers, in order to evaporate the elimination product, in particular the water (present initially in the polymerization medium and/or formed during the polycondensation), while preventing any formation of solid phase in order to prevent the mixture from setting solid.

The polycondensation reaction is generally carried out at a pressure from approximately 0.5-2.5 MPa (0.5-3.5 MPa) at a temperature of approximately 215-300° C. (180-320° C.). The polycondensation is generally continued in the molten phase at atmospheric or reduced pressure, so as to achieve the desired degree of progression.

The polycondensation product is a molten polymer or prepolymer. It can comprise a vapor phase essentially composed of vapor of the elimination product, in particular water, capable of having been formed and/or vaporized.

This product can be subjected to stages of separation of vapor phase and of finishing in order to achieve the desired degree of polycondensation. The separation of the vapor phase can, for example, be carried out in a device of cyclone type. Such devices are known.

The finishing consists in keeping the polycondensation product in the molten state, under a pressure in the vicinity of atmospheric pressure or under reduced pressure, for a time sufficient to achieve the desired degree of progression. Such an operation is known to a person skilled in the art. The temperature of the finishing stage is advantageously greater than or equal to 200° C. and in all cases greater than the temperature at which the polymer solidifies. The residence time in the finishing device is preferably greater than or equal to 5 minutes.

The polycondensation product can also be subjected to a solid-phase post condensation stage. This stage is known to a person skilled in the art and makes it possible to increase the degree of polycondensation to a desired value.

The process of the invention is similar in its conditions to the conventional process for the preparation of polyamide of the type of those obtained from dicarboxylic acids and diamines, in particular to the process for the manufacture of polyamide 6,6 from adipic acid and hexamethylenediamine. This process for the manufacture of polyamide 6,6 is known to a person skilled in the art. The process for the manufacture of polyamide of the type of those obtained from dicarboxylic acids and diamines generally uses, as starting material, a salt obtained by mixing a diacid with a diamine in stoichiometric amount, generally in a solvent, such as water. Thus, in the manufacture of poly(hexamethylene adipamide), the adipic acid is mixed with hexamethylenediamine, generally in water, in order to obtain hexamethylenediammonium adipate, better known under the name of Nylon salt or “N Salt”.

Thus, when the process of the invention employs a diacid compound c), this compound c) and the diamine compound b) can be introduced, at least in part, in the form of a salt of compound c) and of compound b). In particular, when the compound c) is adipic acid and the compound b) is hexamethylenediamine, these compounds can be introduced at least in part in the N salt form.

This makes it possible to have a stoichiometric equilibrium.

The process of the invention generally results in a random polymer.

The semiaromatic polyamide-imide obtained by the process of the invention comprises the repeat units indicated above. However, the polyamide-imide obtained can also comprise the following bisimide repeat units:

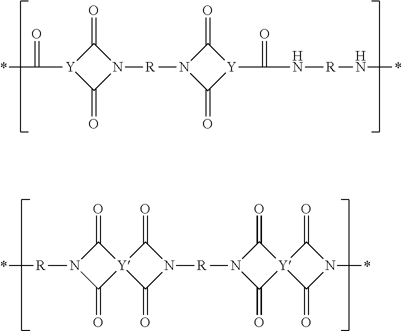

The presence of these bisimide repeat units makes it possible in particular to increase the crystallinity of the polyamide-imide obtained.

The process of the invention is a process which is simple and easy to carry out and which does not employ possibly toxic organic solvents.

The polyamide-imide obtained according to the process of the invention can be used directly without an additional stage, for example in order to recover the polymer, as is the case, for example, in solution preparation processes.

The polyamide-imide obtained at the end of the finishing stage can be cooled and formed into granules.

The polyamide-imide obtained by the process of the invention in the molten form can be directly formed or can be extruded and granulated for subsequent forming after melting.

The polyamide-imide can be used in a large number of applications, in particular in the manufacture of yarns, fibers or filaments, or films, or in the forming of articles by injection molding, extrusion or extrusion/blow molding. It can in particular be used in engineered plastic compositions.

The invention relates, in a second subject matter, to a polyamide-imide comprising the following repeat units:

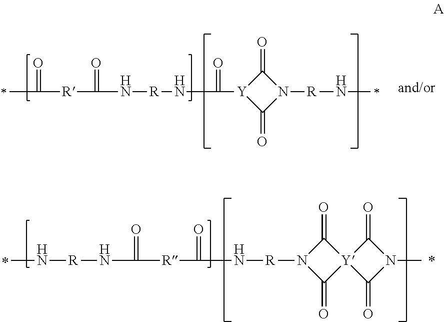

with R and R′ being aliphatic, cycloaliphatic or arylaliphatic hydrocarbon radicals, advantageously aliphatic or cycloaliphatic hydrocarbon radicals, preferably comprising between 2 and 18 carbon atoms,
R″ being a hydrocarbon radical preferably comprising between 2 and 18 carbon atoms,
Y being a trivalent aromatic hydrocarbon radical,
Y′ being a tetravalent aromatic hydrocarbon radical,
or a polyamide-imide comprising the following repeat units:

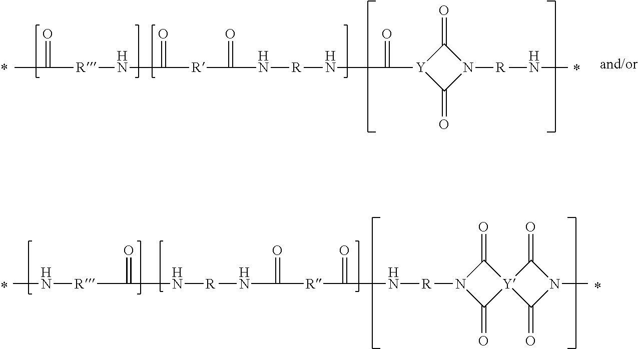

with R, R′ and R″ being hydrocarbon radicals preferably comprising between 2 and 18 carbon atoms,
R′″ being an aromatic hydrocarbon radical preferably comprising between 2 and 18 carbon atoms,
Y being a trivalent aromatic or aliphatic hydrocarbon radical, preferably an aromatic hydrocarbon radical,
Y′ being a tetravalent aromatic or aliphatic hydrocarbon radical, preferably an aromatic hydrocarbon radical.

Advantageously, such a polyamide-imide does not comprise a unit resulting from a diol monomer.

According to a specific embodiment of the invention, the polyamide-imide advantageously comprises at least 60 mol %, preferably at least 80 mol %, of repeat units A.

The polyamide-imides of the invention exhibit the advantage of being easy to convert by the molten route, like aliphatic polyamides, for example, which facilitates the forming thereof. Furthermore, they generally exhibit improved thermomechanical properties, in particular the HDT (Heat Distortion Temperature) property. Finally, they show better water uptake properties, in comparison with aliphatic polyamides, and a reduced thermal expansion, in comparison with aliphatic polyamides.

The polyamide-imide of the invention can be used alone or as component of a composition. It can be used particularly as additive in thermoplastic polymer compositions comprising a thermoplastic matrix. It participates in the composition in particular as reinforcing agent. The thermoplastic matrix is a thermoplastic polymer.

Mention is made, as examples of polymers which may be suitable, of: polylactones, such as poly(pivalo-lactone), poly(caprolactone) and polymers of the same family; polyurethanes obtained by reaction between diisocyanates, such as 1,5-naphthalene diisocyanate, p-phenylene diisocyanate, m-phenylene diisocyanate, 2,4-toluene diisocyanate, 4,4′-diphenylmethane diisocyanate, 3,3′-dimethyl-4,4′-diphenylmethane diisocyanate, 3,3′-dimethyl-4,4′-biphenyl diisocyanate, 4,4′-diphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, toluidine diisocyanate, hexamethylene diisocyanate, 4,4′-diisocyanatodiphenylmethane and compounds of the same family, and diols with long linear chains, such as poly(tetramethylene adipate), poly(ethylene adipate), poly(1,4-butylene adipate), poly(ethylene succinate), poly(2,3-butylene succinate), polyether diols and compounds of the same family; polycarbonates, such as poly[methanebis(4-phenyl)carbonate], poly[1,1-etherbis-(4-phenyl)carbonate], poly[diphenylmethanebis(4-phenyl)carbonate], poly[1,1-cyclohexanebis(4-phenyl)-carbonate] and polymers of the same family; polysulfones; polyethers; polyketones; polyamides, such as poly(4-aminobutyric acid), poly(hexamethylene adipamide), poly(6-aminohexanoic acid), poly(m-xylylene adipamide), poly(p-xylylene sebacamide), poly(2,2,2-trimethylhexamethylene terephthalamide), poly(meta-phenylene isophthalamide), poly(p-phenylene terephthalamide) and polymers of the same family; polyesters, such as poly(ethylene azelate), poly(ethylene 1,5-naphthalate), poly(1,4-cyclohexane-dimethylene terephthalate), poly(ethylene oxybenzoate), poly(para-hydroxybenzoate), poly(1,4-cyclohexylidene-dimethylene terephthalate), poly(1,4-cyclohexylidene-dimethylene terephthalate), polyethylene terephthalate, polypropylene terephthalate, polybutylene terephthalate and polymers of the same family; poly(arylene oxide)s, such as poly(2,6-dimethyl-1,4-phenylene oxide), poly(2,6-diphenyl-1,4-phenylene oxide) and polymers of the same family; poly(arylene sulfide)s, such as poly(phenylene sulfide) and polymers of the same family; polyetherimides; vinyl polymers and their copolymers, such as polyvinyl acetate, polyvinyl alcohol, polyvinyl chloride, polyvinylbutyral, polyvinylidene chloride, ethylene-vinyl acetate copolymers and polymers of the same family; acrylic polymers, polyacrylates and their copolymers, such as polyethyl acrylate, poly(n-butyl acrylate), polymethyl methacrylate, polyethyl methacrylate, poly(n-butyl methacrylate), poly(n-propyl methacrylate), polyacrylamide, polyacrylonitrile, poly(acrylic acid), ethylene-acrylic acid copolymers, ethylene-vinyl alcohol copolymers, acrylonitrile copolymers, methyl methacrylate-styrene copolymers, ethylene-ethyl acrylate copolymers, methacrylate-butadiene-styrene copolymers, ABS and polymers of the same family; polyolefins, such as low density poly(ethylene), poly(propylene), low density chlorinated poly-(ethylene), poly(4-methyl-1-pentene), poly(ethylene), poly(styrene) and polymers of the same family; ionomers; poly(epichlorohydrin)s; poly(urethane)s, such as polymerization products of diols, such as glycerol, trimethylolpropane, 1,2,6-hexanetriol, sorbitol, pentaerythritol, polyether polyols, polyester polyols and compounds of the same family, with polyisocyanates, such as 2,4-tolylene diisocyanate, 2,6-tolylene diisocyanate, 4,4′-diphenylmethane diisocyanate, 1,6-hexamethylene diisocyanate, 4,4′-dicyclohexylmethane diisocyanate and compounds of the same family; polysulfones, such as the products of reaction between a sodium salt of 2,2-bis(4-hydroxyphenyl)propane and 4,4′-dichlorodiphenyl sulfone; furan resins, such as poly(furan); cellulose ester plastics, such as cellulose acetate, cellulose acetate butyrate, cellulose propionate and polymers of the same family; silicones, such as poly(dimethylsiloxane), poly(di-methylsiloxane-co-phenylmethylsiloxane) and polymers of the same family; and blends of at least two of the above polymers.

According to a specific alternative form of the invention, the thermoplastic matrix is a polymer comprising star-shaped or H-shaped macromolecular chains and, if appropriate, linear macromolecular chains. The polymers comprising such star-shaped or H-shaped macromolecular chains are described, for example, in the documents FR 2 743 077, FR 2 779 730, U.S. Pat. No. 5,959,069, EP 0 632 703, EP 0 682 057 and EP 0 832 149.

According to another specific alternative form of the invention, the thermoplastic matrix of the invention is a polymer of random tree type, preferably a copolyamide exhibiting a random tree structure. These copolyamides with a random tree structure and their process of preparation are described in particular in the document WO 99/03909.

The thermoplastic matrix of the invention can also be a composition comprising a linear thermoplastic polymer and a star-shaped, H-shaped and/or tree thermoplastic polymer as are described above.

The compositions of the invention can also comprise a hyperbranched copolyamide of the type of those described in the document WO 00/68298.

The compositions of the invention can also comprise any combination of star-shaped, H-shaped or tree thermoplastic polymer or hyperbranched copolyamide described above.

Mention may be made, as other type of polymeric matrix which can be employed in the context of the invention, of thermally stable polymers: these polymers are preferably infusible or exhibit a softening point of greater than 180° C., preferably ≧200° C., or greater. These thermally stable polymers can, for example, be chosen from aromatic polyamides, polyamide-imides, such as polytrimellamide-imides, or polyimides, such as the polyimides obtained according to the document EP 0 119 185, known commercially under the P84 trade name. The aromatic polyamides can be as described in patent EP 0 360 707. They can be obtained according to the process described in patent EP 0 360 707.

Mention may also be made, as other polymeric matrix, of viscose, cellulose, cellulose acetate, and the like.

The polymeric matrix of the invention can also be of the type of the polymers used in adhesives, such as vinyl acetate copolymer plastisols, acrylic latices, urethane latices, PVC plastisols, and the like.

Preference is very particularly given, among these polymeric matrices, to semicrystalline polyamides, such as polyamide 6, polyamide 6,6, polyamide 11, polyamide 12, polyamide 4, polyamides 4,6, 6,10, 6,12, 6,36 and 12,12, and semiaromatic polyamides obtained from terephthalic and/or isophthalic acid, such as the polyamide sold under the trade name Amodel; polyesters, such as PET, PBT or PTT; polyolefins, such as polypropylene or polyethylene; aromatic polyamides, polyamide-imides or polyimides; latices, such as acrylic and urethane latices; PVC, viscose, cellulose or cellulose acetate; or their copolymers and alloys.

The compositions can comprise any other additive which can be used, for example reinforcing fillers, flame-retardants, UV stabilizers, heat stabilizers or mattifying agents, such as titanium dioxide.

The compositions according to the invention are preferably obtained by melt blending the thermoplastic polymer and the polyamide-imide. The blending can, for example, be carried out using an extrusion device, for example a single-screw or twin-screw mixer.

The proportion by weight of polyamide-imide in the composition is advantageously between 1 and 99%, preferably between 5 and 30%.

The compositions according to the invention can be used as starting material in the field of engineered plastics, for example in the production of articles molded by injection molding or by injection/blow molding, extruded by conventional extrusion or extruded by extrusion/blow-molding, or of films.

The compositions according to the invention can also be put into the form of yarns, fibers or filaments by melt spinning.

Other details or advantages of the invention will become more clearly apparent in the light of the examples given below.

### EXAMPLES

### Characterizations

Absolute molar mass: determined by gel permeation chromatography (GPC) in dichloromethane (+trifluoroacetic anhydride), followed by three-fold detection by refractometry RI, UV absorption and viscometry.

Degree of cyclization to give imide: determined by ¹H NMR at 300K in deuterated formic acid using a Bruker DRX 300 MHz device.

Melting point (Tm) and associated enthalpy (ΔHf), glass transition temperature (Tg) and crystallization temperature on cooling (Tc): determined by differential scanning calorimetry (DSC) using a Perkin Elmer Pyris 1 device at a rate of 10° C./min.

Contents of acid and amine end groups: titrated by potentiometry

Viscosity number (VN): measured according to the standard ISO EN 307.

### Example 1

### Preparation of a Polyamide-Imide PAI 6,6/6,TMA 90/10

132.37 g (0.505 mol) of N salt (1:1 salt of hexamethylenediamine and of adipic acid), 11.78 g of trimellitic acid (TMLA) (0.056 mol), 19.99 g of a solution of hexamethylenediamine (HMD) in solution of water at 32.6% by weight (0.056 mol) and 123.65 g of demineralized water and 2 g of antifoaming agent are introduced into a polymerization reactor.

The polyamide-imide is manufactured according to a standard process for polymerization of polyamide 6,6 type.

The polymer obtained is cast in the rod form, cooled and formed into granules by cutting the rods.

The polymer obtained exhibits the following characteristics:

Mn=9700 g/mol

Tg=63° C., Tc=204.2° C., Tm=247.2° C.

The ¹H NMR analysis indicates complete cyclization to give imide.

### Examples 2 to 7

In examples 2 to 7, polyamide-imides of the PAI 6,6/6,TMA type with a molar composition of 80/20 (example 2), 67/33 (example 3), 60/40 (example 4), 50/50 (example 5), 30/70 (example 6) and 15/85 (example 7) are prepared according to a standard process for polymerization of polyamide 6,6 type, as in example 1.

The compositions (all the compositions comprise 2 g of antifoaming agent) and characterizations of these polymers are given in the following table 1.

TABLE 1

| | | | | HMD at | | | | | |
|---|---|---|---|---|---|---|---|---|---|
| | | | | 32.6% | | | | | |
| | PAI | N salt | TMLA | in water | Water | Mn | Tc | Tg | Tm |
| Example | 6, 6/6, TMA | (g) | (g) | (g) | (g) | (g/mol) | (° C.) | (° C.) | (° C.) |
| 2 | 6, 6/6, TMA | 115.3 | 23.08 | 39.17 | 114.40 | 11 000 | 176.7 | 66.3 | 234.4 |
| | 80/20 | | | | | | | | |
| 3 | 6, 6/6, TMA | 94.23 | 37.17 | 63.02 | 95.79 | — | 137.1 | 68.5 | 211.6 |
| | 67/33 | | | | | | | | |
| 4 | 6, 6/6, TMA | 83.28 | 44.47 | 75.44 | 87.79 | 12 100 | 133.7 | 69 | 197.9 |
| | 60/40 | | | | | | | | |
| 5 | 6, 6/6, TMA | 68.10 | 54.53 | 92.48 | 76.73 | 12 400 | — | 75.9 | — |
| | 50/50 | | | | | | | | |
| 6 | 6, 6/6, TMA | 39.43 | 73.68 | 125.00 | 56.12 | 12 300 | — | 92.2 | — |
| | 30/70 | | | | | | | | |
| 7 | 6, 6/6, TMA | 19.19 | 87.15 | 147.83 | 41.10 | 10 500 | — | 105.2 | — |
| | 15/85 | | | | | | | | |

The ¹H NMR analysis indicates complete cyclization to give imide for examples 2 to 7.

### Example 8

### Preparation of a Polyamide-Imide from Trimellitic Anhydride

In this example, trimellitic anhydride is used instead of trimellitic acid.

115.37 g of N salt, 21.80 g of 97% trimellitic anhydride, 39.19 g of 32.6% by weight solution of hexamethylenediamine in water and 9.39 g of demineralized water and 2 g of antifoaming agent are introduced into a polymerization reactor.

The polyamide-imide is manufactured according to a standard process for polymerization of polyamide 6,6 type, as in example 1.

The polymer obtained is cast in the rod form, cooled and formed into granules by cutting the rods.

The polymer obtained exhibits the following characteristics:

Mn=9800 g/mol

Tc=186.6° C., Tm=234.5° C.

The ¹H NMR analysis indicates complete cyclization to give imide.

The analyses do not show major differences between the polymers synthesized with trimellitic anhydride or with trimellitic acid.

### Example 9

### Preparation of a Polyamide-Imide PAI 6,TMA

99.90 g of trimellitic acid, 169.49 g of 32.6% by weight HMD in water and 27.08 g of demineralized water and 2 g of antifoaming agent are introduced into a polymerization reactor.

The polyamide-imide is manufactured according to a standard process for polymerization of polyamide 6,6 type, as in example 1.

The polymer obtained is cast in the rod form, cooled and formed into granules by cutting the rods.

The polymer obtained exhibits the following characteristics:

Mn=9800 g/mol

Tg=120.2° C.

The polymer is amorphous.

The ¹H NMR analysis indicates complete cyclization to give imide.

### Example 10

### Preparation of a Polyamide-Imide PAI 6,6/6,PMDA 95/5

140.43 g of N salt, 7.16 g of pyromellitic acid, 10.04 g of 32.6% by weight HMD in water and 130.58 g of demineralized water and 2 g of antifoaming agent are introduced into a polymerization reactor.

The polyamide-imide is manufactured according to a standard process for polymerization of polyamide 6,6 type, as in example 1.

The polymer obtained is cast in the rod form, cooled and formed into granules by cutting the rods.

The polymer obtained exhibits the following characteristics:

Mn=9400 g/mol

Tc=220.2° C., Tm=255.1° C.

The ¹H NMR analysis indicates complete cyclization to give imide.

### Example 11

### Preparation of a Polyamide-Imide PAI 6,6/6,T/6,TMA 57/38/5

82.11 g of N salt (1:1 salt of hexamethylenediamine and adipic acid), 58.92 g of a 6,T salt (1:1 salt of hexamethylenediamine and terephthalic acid), 5.84 g of trimellitic acid (TMLA), 10.48 g of a solution of hexamethylenediamine (HMD) in solution in water at 32.65% by weight and 137.3 g of demineralized water and 2 g of antifoaming agent are introduced into a polymerization reactor.

The polyamide-imide is manufactured according to a standard process for polymerization of polyamide 6,6 type.

The polymer obtained is cast in the rod form, cooled and formed into granules by cutting the rods.

The polymer obtained exhibits the following characteristics:

Tc=238.4° C., Tm=271.9° C.

The ¹H NMR analysis indicates complete cyclization to give imide.

### Examples 12 to 17

### Preparation of Compositions Comprising a Polyamide and a Polyamide-Imide According to the Invention

Compositions comprising a polyamide PA 6,6 and a polyamide-imide PAI 6,TMA were prepared in a DSM MIDI 2000 microextruder (microcompounder) (15 cm³) at a temperature of 275° C. The proportions by weight of the compositions PA 6,6/PAI 6,TMA prepared are as follows: 90/10, 75/25, 50/50, 25/75 and 10/90.

The polyamide used is a PA 6,6 exhibiting the following characteristics: VN=138.7 ml.g⁻¹, ATG=44.9 meq.kg⁻¹ and CTG=76.9 meq/kg⁻¹. The polyamide-imide used is the polyamide-imide of example 9.

The polyamide PA 6,6 and the polyamide-imide PAI 6,TMA are blended in the microextruder at a temperature of 275° C. and injected into a mold at 70° C. (injection module) in the form of bars with dimensions of 62×12×4 mm³.

DSC thermal analyses are carried out on these bars in order to determine the melting point and also the degree of crystallinity. It is observed that the PA 6,6 achieves the same degree of crystallinity whatever the composition of the blend: the PAI 6,TMA does not interfere with the crystallization of the PA 6,6.

Dynamic mechanical analyses (DMA) are carried out on test specimens cut out from these bars. A sinusoidal stress is applied in 3-point bending with double clamping (frequency 1 Hz and amplitude 0.05%) and the DMA analysis is carried out between +20 and +260° C. (rise at +2.5° C./min). These measurements are carried out on a dynamic measurement (DMA) device, model RSA2 from Rheometrics.

Dynamic mechanical analyses are carried out on these bars in order to determine the miscibility by the search for α transition temperatures (Tα) (equivalent to Tg in dynamic mechanical analysis) and the level of the elastic modulus (E′) at 90° C. Two α transition temperatures are observed, the sign of an immiscibility between the two polymers. The elastic modulus at 90° C. of the PA 6,6 is increased in the presence of PAI 6,TMA.

TABLE 2

| | PA 6, 6/PAI | | | | E′ | |
|---|---|---|---|---|---|---|
| | 6, TMA | Tm | ΔHf | Tα | 90° C. | ΔE′ |
| Example | blend | (° C.) | (J/g) | (° C.) | (GPa) | 90° C. |
| 12 | 100/0 | 267.2 | 71.6 | 66 | 0.69 | — |
| (comparative) | | | | | | |
| 13 | 90/10 | 264.5 | 69.4 | 71 and | 0.72 | +5% |
| | | | | 110 | | |
| 14 | 75/25 | 265.5 | 60.4 | 70 and | 0.84 | +20% |
| | | | | 112 | | |
| 15 | 50/50 | 264.4 | 40 | 73 and | 1.19 | +70% |
| | | | | 113 | | |
| 16 | 25/75 | 261.7 | 18.5 | N.M. | 1.66 | +140% |
| | | | | and | | |
| | | | | 114 | | |
| 17 | 10/90 | 259.7 | 7.8 | N.M. | 1.97 | +185% |
| | | | | and | | |
| | | | | 116 | | |

N.M. = Not Measurable: existence of a Tα but it cannot be measured.

1.-21. (canceled)

22. A process for the preparation of a semi-aromatic polyamideimide comprising melt polymerization of at least the following monomers:
a) at least one organic compound, optionally an aromatic organic compound, comprising at least two carboxyl groups, the carboxyl groups being present in the form of functional groups selected from among carboxylic acid, acid chloride, acid anhydride, amide or ester functional groups, at least two of the carboxyl groups forming an intramolecular anhydride functional group or being adapted to form an intramolecular anhydride functional group,
b) at least one diamine compound, optionally an aliphatic diamine compound,
c) optionally, at least one diacid compound, with the proviso that, when all of the carboxyl groups of the compound a) form an intramolecular anhydride functional group or are adapted to form an intramolecular anhydride functional group, the molar proportion of compound c) with respect to the sum of the compounds a) and c) is greater than or equal to 0.5%.

23. The process as defined by claim 22, wherein said molar proportion is greater than or equal to 25%.

24. The process as defined by claim 22, wherein said molar proportion is greater than or equal to 50%.

25. The process as defined by claim 22, wherein at least 45 mol % of the diamine compound is an aliphatic, cycloaliphatic or arylaliphatic diamine.

26. The process as defined by claim 22, wherein the compound a) comprises three or four carboxyl groups.

27. The process as defined by claim 26, wherein the compound a) comprises three or four carboxylic acid functional groups.

28. The process as defined by claim 22, wherein the compound a) has the following formula (I):
Z—(COOH)₃
in which Z is a trivalent aromatic hydrocarbon radical.

29. The process as defined by claim 28, wherein Z has from 6 to 18 carbon atoms.

30. The process as defined by claim 22, wherein the compound a) is selected from among trimellitic acid, pyromellitic acid, or anhydrides, esters or amides thereof.

31. The process as defined by claim 22, wherein the compound b) has the following formula (II):
H₂N—R—NH₂ (II)
in which R is a divalent aliphatic, cycloaliphatic, arylaliphatic or aromatic hydrocarbon radical.

32. The process as defined by claim 31, wherein the radical R has from 2 to 18 carbon atoms.

33. The process as defined by claim 22, wherein the compound b) is an aliphatic diamine.

34. The process as defined by claim 22, wherein at least one compound c) is polymerized which has the following formula (III):
HOOC—R′—COOH (III)
in which R′ is a divalent aliphatic, cycloaliphatic, arylaliphatic or aromatic hydrocarbon radical.

35. The process as defined by claim 34, wherein the radical R′ has from 2 to 18 carbon atoms.

36. The process as defined by claim 34, wherein the compound c) comprises an aliphatic diacid.

37. The process as defined by claim 22, wherein it does not comprise polymerization of aliphatic amino acid or lactam monomers.

38. The process as defined by claim 22, wherein it does not comprise polymerization of diol monomers.

39. A polyamideimide comprising the following repeat structural units: 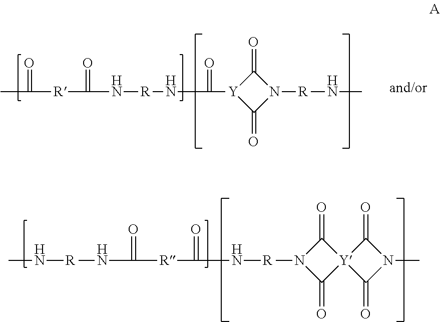
wherein:
R and R′ are aliphatic, cycloaliphatic or arylaliphatic hydrocarbon radicals having from 2 to 18 carbon atoms,
R″ is a hydrocarbon radical having from 2 to 18 carbon atoms,
Y is a trivalent aromatic hydrocarbon radical, and
Y′ is a tetravalent aromatic hydrocarbon radical.

40. The polyamideimide as defined by claim 39, comprising at least 60 mol % of repeat structural units A.

41. The polyamideimide as defined by claim 39, devoid of a structural unit resulting from a diol monomer.

42. A polyamideimide comprising the following repeat structural units: 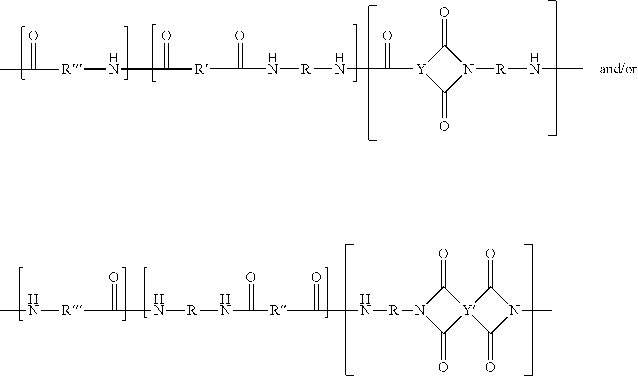
wherein:
R, R′ and R″ are hydrocarbon radicals having from 2 to 18 carbon atoms,
R′″ is an aromatic hydrocarbon radical having from 2 to 18 carbon atoms,
Y is a trivalent aromatic or aliphatic hydrocarbon radical, and
Y′ is a tetravalent aromatic or aliphatic hydrocarbon radical.

43. A thermoplastic polymer composition comprising at least one semi-aromatic polyamideimide as defined by claim 39 and a thermoplastic matrix.

44. A shaped article formed from the thermoplastic composition as defined by claim 43, by molding, injection molding, injection/blow molding, extrusion/blow molding, extrusion or spinning.
